(19) United States
(12) Patent Application Publication
(10) Pub. No.: US 2003/0033359 A1
(43) Pub. Date: Feb. 13, 2003

(54) Server for managing load, program and medium

(75) Inventor: Youichirou Asoh, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/095,437

(22) Filed: Mar. 13, 2002

(30) Foreign Application Priority Data
Aug. 10, 2001 (JP) 2001-243176

(51) Int. Cl. G06F 15/16

(52) U.S. Cl. 709/203; 709/230

(57) ABSTRACT

A server providing a function to a terminal on a network comprises a communication module receiving a connection request from a terminal (A-E) on a network, a processing unit (1) providing a function to the terminal (A-E) connected, a load judging module (21) judging a load of the processing unit, a reservation module reserving a connection of a terminal (A-E) of which a connection is rejected, and a control module (22) controlling the connection of the terminal (A-E). The control module (22), when the load of the processing unit (1) exceeds a predetermined range, rejects the connection request but reserves the connection of the terminal (A-E) in the reservation module, and, when the load of the processing unit falls within the predetermined range, connects the terminal (A-E) with reservation already made.

### BACKGROUND OF THE INVENTION

The present invention relates to a load sharing technology in a network.

With developments of computer-based information processing technologies and network-based communication technologies, various categories of information can be easily obtained or transmitted. Further, a variety of information processes can be executed by utilizing multiple remote-stationed computers.

For example, a desired item of information can be obtained when the necessity may arise by accessing a web site on the Internet. Further, the users often utilize a high-performance server via a LAN (Local Area Network) in a way that the users individually use personal computers. This is, for instance, a case of accessing online systems and databases managed in concentration. Moreover, there is a case in which the server executes calculating algorithms with a heavy load, and results thereof are obtained on the personal computer.

Thus, much serviceability can be gained owing to the developments of the information communication technologies. While on the other hand, however, there arise troubles due to a congestion of accessing from the users. For instance, for a specific period of time, a traffic congestion occurs on a specific route in the network, and a load upon a specific node becomes extremely heavy.

If the congestion of accessing o a Web page on the Internet from the users occurs for the given period of time, a trouble of the traffic on the specific route is liable to occur. On the other hand, in a LAN-linked environment, the load on the server increases more easily than the traffic on the network in such a case.

According to the conventional system, the processes (jobs) have hitherto been allocated to a plurality of servers by the following four types of systems in order to reduce the server load described above.

(1) Round-Robin System

According to the round-robin system, the order of allocating the jobs to the plurality of servers is predetermined, and processing requests from the users are allocated to the respective server in this order.

(2) Random System

According to this system, the processing requests from the users are allocated to the servers at random.

(3) Operation Monitoring System

A scheme according to this system, in addition to the load distributions as by the systems (1) and (2) described above, is load-sharing in a way that monitors the loads on the respective servers. Namely, according to this operation monitoring system, an operating state of the server, e.g., a response time of the server is always checked, and no process (job) is allocated to the server exhibiting a slow response.

(4) Load Monitoring System

According to this system, in addition to the operation monitoring system, a further load, i.e., a CPU activity ratio is monitored, and the process is allocated to the server having a less load.

In any systems described above, however, the accesses from the users are congested with the result that the users are unable to access the server. In such a case, the users have nothing but to repeatedly access the server or retry accessing several hours later.

### SUMMARY OF THE INVENTION

It is a primary object of the present invention, which was devised in view of the problems inherent in the prior art, to obviate a user's stress caused by an unaccessible state by reducing a load on a server due to repetitive accessing by a user.

To accomplish the above object, according to one aspect of the present invention, a server for providing a function to a terminal on a network comprises a communication module receiving a connection request from a terminal (A-E) on a network, a processing unit (1) providing a function to the terminal (A-E) connected, a load judging module (21) judging a load of the processing unit (1), a reservation module reserving a connection of a terminal (A-E) of which a connection is rejected, and a control module (22) controlling the connection of the terminal (A-E), wherein the control module (22), when the load of the processing unit exceeds a predetermined range, rejects the connection request but reserves the connection of the terminal (A-E) in the reservation module, and, when the load of the processing unit falls within the predetermined range, connects the terminal (A-E) with reservation already made.

Herein, the processing unit (1) is, e.g., a CPU etc for executing an application program on the server. Further, the load judging module (21) may be defined as a program executed within the server or by a computer different from the server. More over, the reservation module may be defined as, e.g., a table for managing a reservation state of the terminal.

As described above, the control module (22) judges the load of the processing unit and, when this load exceeds the predetermined range, rejects the connection request. An overload can be thereby prevented from occurring in the processing unit (1), i.e., the server.

Further, the control module (22) reserves the connection of the terminal (A-E) in the reservation module, and connects the terminal (A-E) with the reservation already made when the load of the processing unit falls within the predetermined range. Each terminal (A-E) can be thereby surely connected to the server.

Preferably, the control module (22) may give, in the reservation, a piece of reservation identifying information to the terminal (A-E) of which the connection has been reserved, give a piece of permission information to the terminal (A-E) with the reservation already made in sequence of reservation priorities when the load of the processing unit falls within the predetermined range, and, when the terminal (A-E) given the permission information makes a connection request with the reservation identifying information shown, connect the terminal (A-E).

The reservation identifying information is, e.g., a unique reservation number that identifies the reservation. Further, the server may notify the terminal (A-E) of the permission information by, for instance, e-mail. Thus, the user of the terminal is able to surely connect its terminal to the server because of being notified of the permission information when connectable.

Preferably, the permission information may contain a piece of authenticating information mapped to the reservation identifying information, and the control module (22) may, when the terminal (A-E) shows the reservation identifying information and the authenticating information, connect the terminal (A-E). Thus, the connection request from the terminal is identified based on the reservation identifying information and the authenticating information, so that a connection request from an invalid terminal can be eliminated.

Preferably, the server may further comprise a setting module (34) setting information for specifying a destination to which the permission information is transmitted. The permission information may also be transmitted to this transmitting destination.

According to another aspect of the present invention, a server providing a function to a terminal (A-E) on a network and communicating a notification related to the terminal (A-E) to a predetermined communication terminal (A1-E1), comprises a communication module receiving a connection request from a terminal (A-E) on a network, a processing unit (1) providing a function to the terminal (A-E) connected, a load judging module (21) judging a load of the processing unit (1), a reservation module reserving a connection of a terminal (A-E) of which a connection is rejected, and a control module (22) controlling the connection of the terminal (A-E), wherein the control module (22), when the load of the processing unit (1) exceeds a predetermined range, rejects the connection request but reserves the connection of the terminal (A-E) in the reservation module, and, when the load of the processing unit (1) falls within the predetermined range if the connection of the terminal (A-E) is reserved in the reservation module, gives the permission information indicating a permission of the connection to the communication terminal (A1-E1).

According to yet another aspect of the present invention, a terminal (A-E) connected to a server on a network and provided with a function from the server, comprises a communication module making a connection request to the server, a recording module recording information, and a control module controlling the connection to the server, wherein the control module, when the connection is rejected, receives and records the recording module with a piece of reservation identifying information indicating a reservation of connection, and when making the connection request to the server next time, shows the reservation identifying information.

Thus, when the request of connection is rejected by the server, the terminal records the reservation identifying information and, when making the connection request to the server next time, shows the reservation identifying information. Therefore, the user has no necessity of being aware of the reservation identifying information.

According to a further aspect of the present invention, a load management method, comprises receiving a connection request from a terminal on a network (S1), controlling a processing unit (1) actualizing a predetermined function to provide this function to the terminal connected, judging a load of the processing unit (S3, S4), connecting the terminal making the connection request when the load of the processing unit does not exceed a predetermined range (S5), rejecting, when the load of the processing unit exceeds the predetermined range, the connection request but reserving the connection of the terminal in the reservation module (S74), and connecting, when the load of the processing unit falls within the predetermined range, the terminal with the reservation already made (S18).

According to a still further aspect of, the present invention, there is provided a program executed by a computer to actualize any one of the functions described above.

According to a yet further aspect of the present invention, there is provided a readable-by-computer recording medium recorded with such a program.

As explained above, according to the present invention, it is possible to reduce the server load due to the user's repeatedly accessing the overload server. Further, the user's stress caused by being unaccessible can be relieved.

### BRIEF DESCRIPTION OF THE DRAWINGS

FIG. 1 is a view showing an architecture as a principle of a load sharing system 2 in one embodiment of the present invention;

FIG. 2 is a diagram showing state transitions of a terminal;

FIG. 3 is a diagram showing an example of a screen displayed on the terminal;

FIG. 4 is a diagram showing an example of a terminal table used by the load sharing system 2;

FIG. 5 is a flowchart showing processes in the whole system including a server 1, the load sharing system 2 and the terminals;

FIG. 6 is a flowchart showing details of a server load state check process (S2 in FIG. 5) through a reservation number notifying process (S11 in FIG. 5);

FIG. 7 is a flowchart showing details of a wait-for-server selecting process (S7 in FIG. 5) through a re-connection request process (S16 in FIG. 5) in the terminal;

FIG. 8 is a flowchart showing a priority transit process in the load sharing system 2;

FIG. 9 is a flowchart showing details of the reservation number check process in the load sharing system 2; and

FIG. 10 is a view showing a modified example of the present invention, which utilizes a mobile terminal.

### DETAILED DESCRIPTION OF THE PREFERRED EMBODIMENT

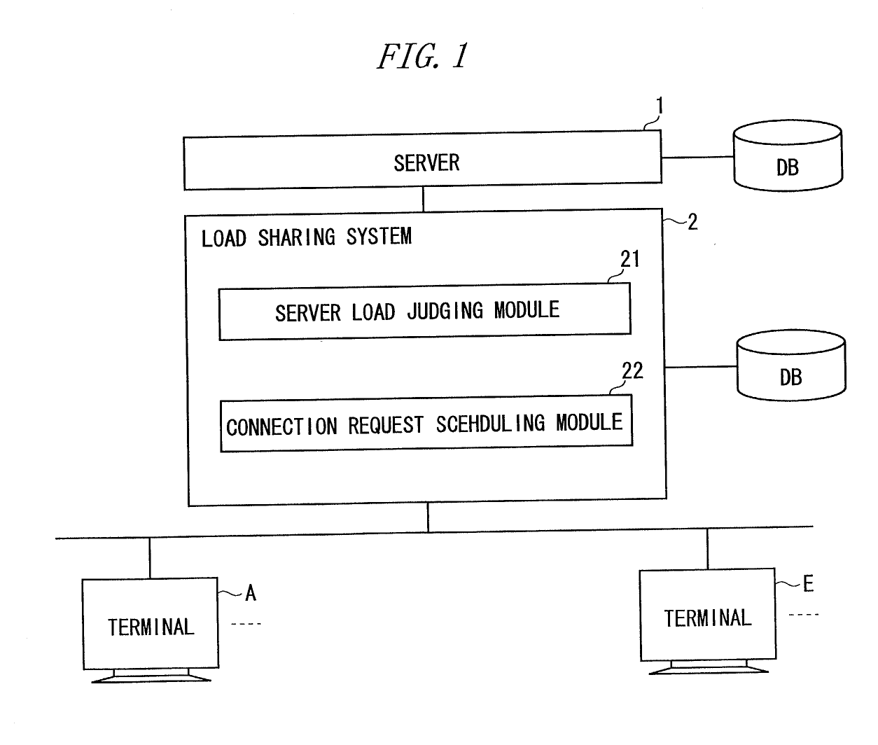

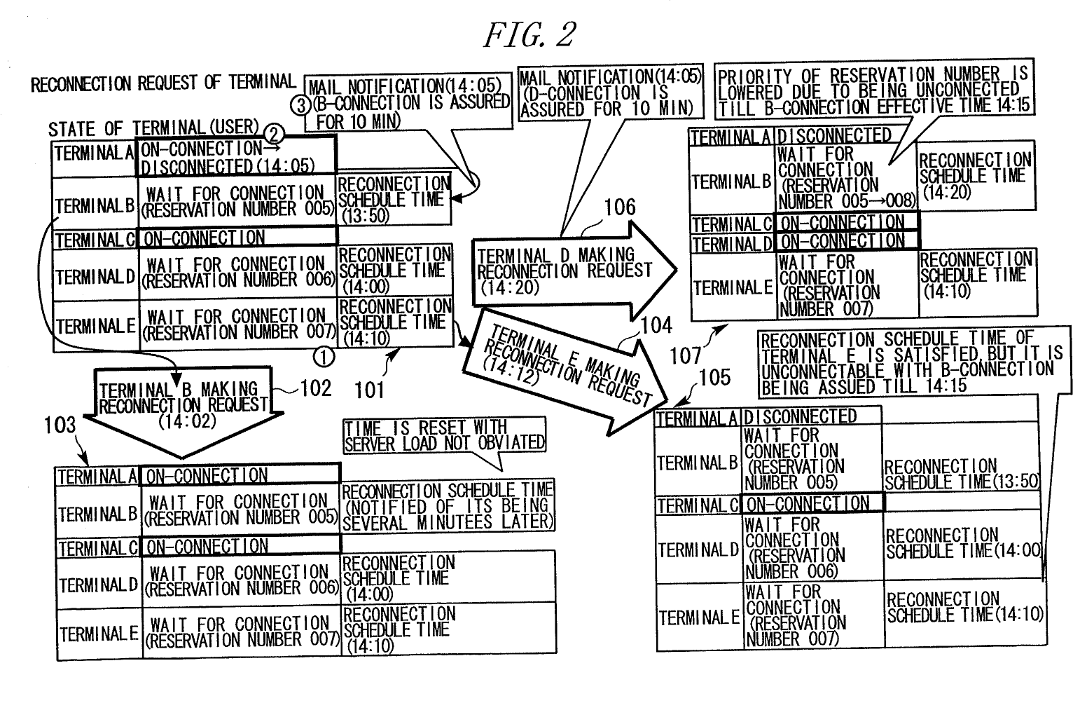

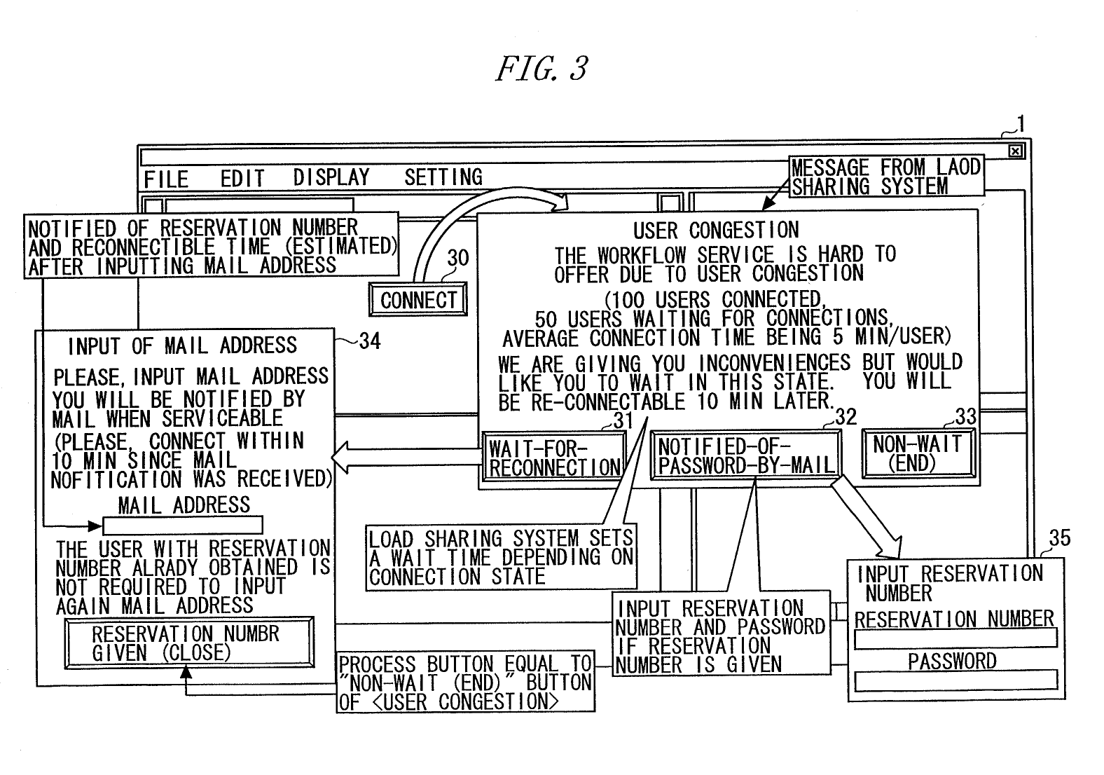

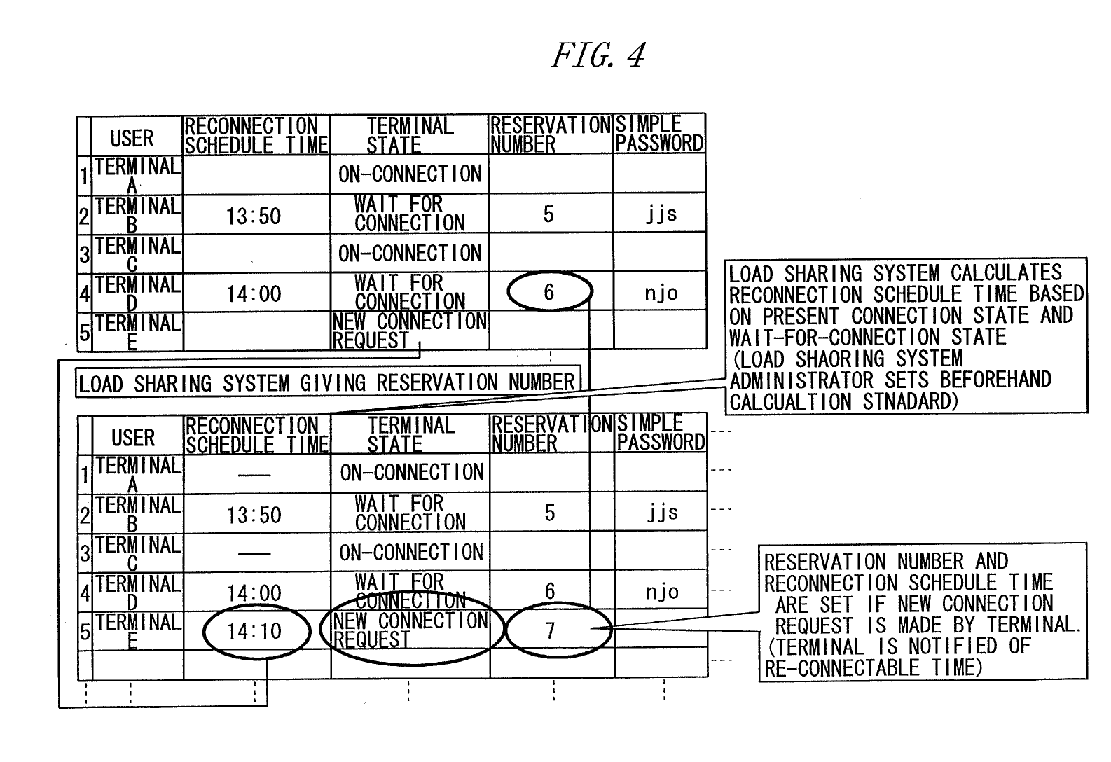

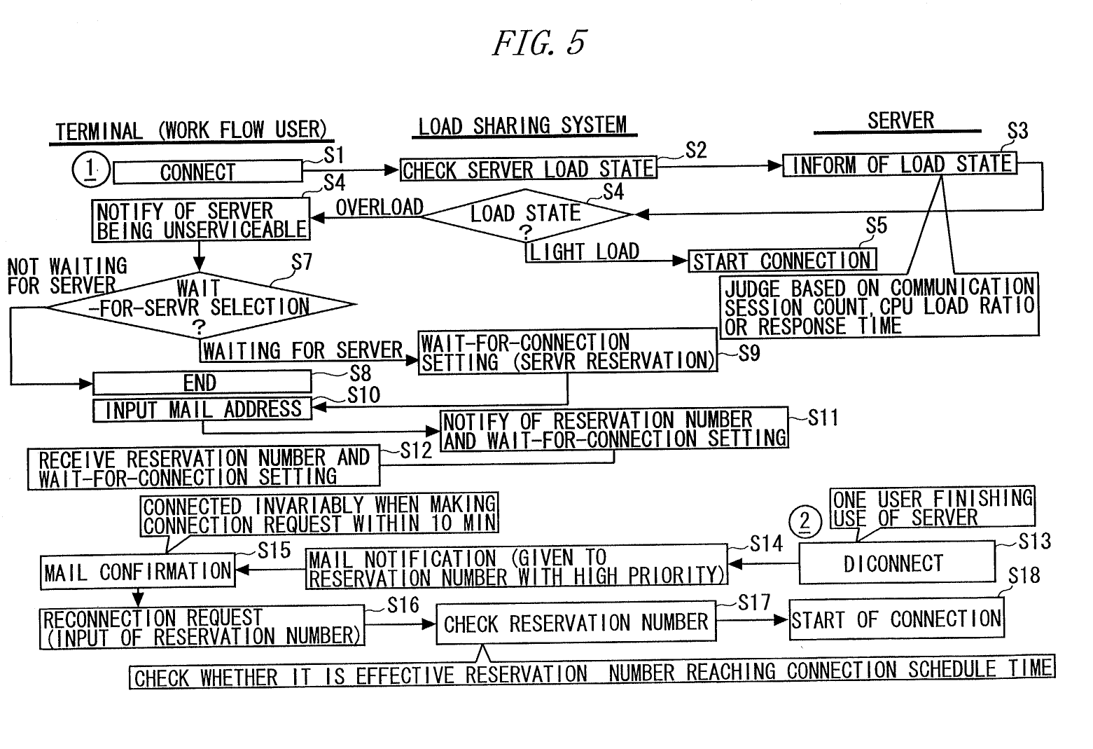

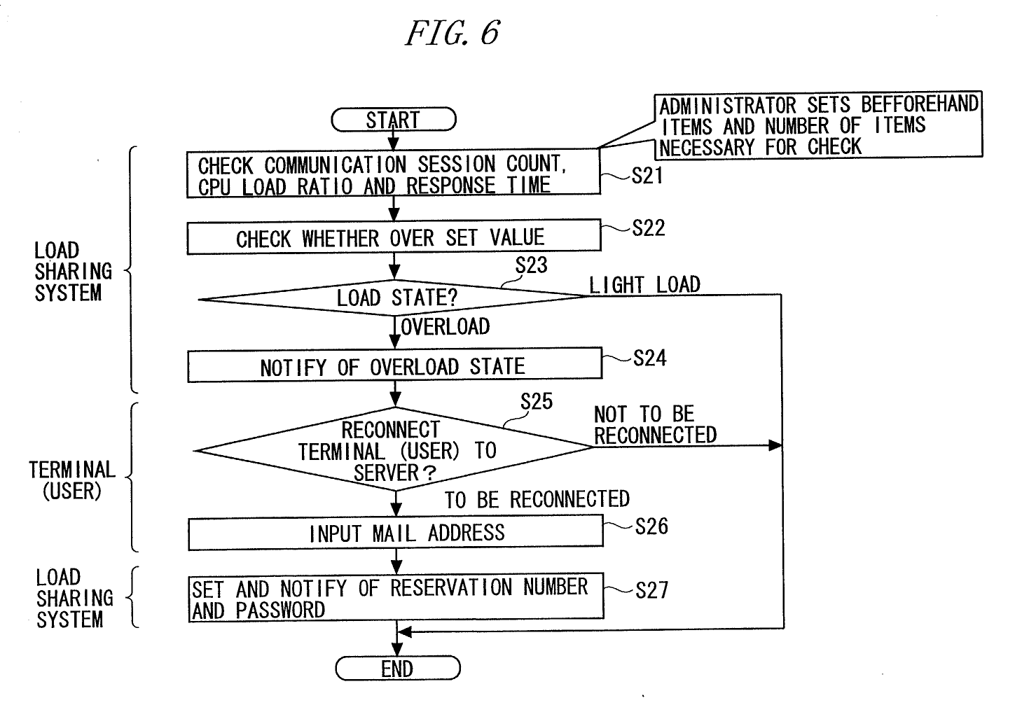

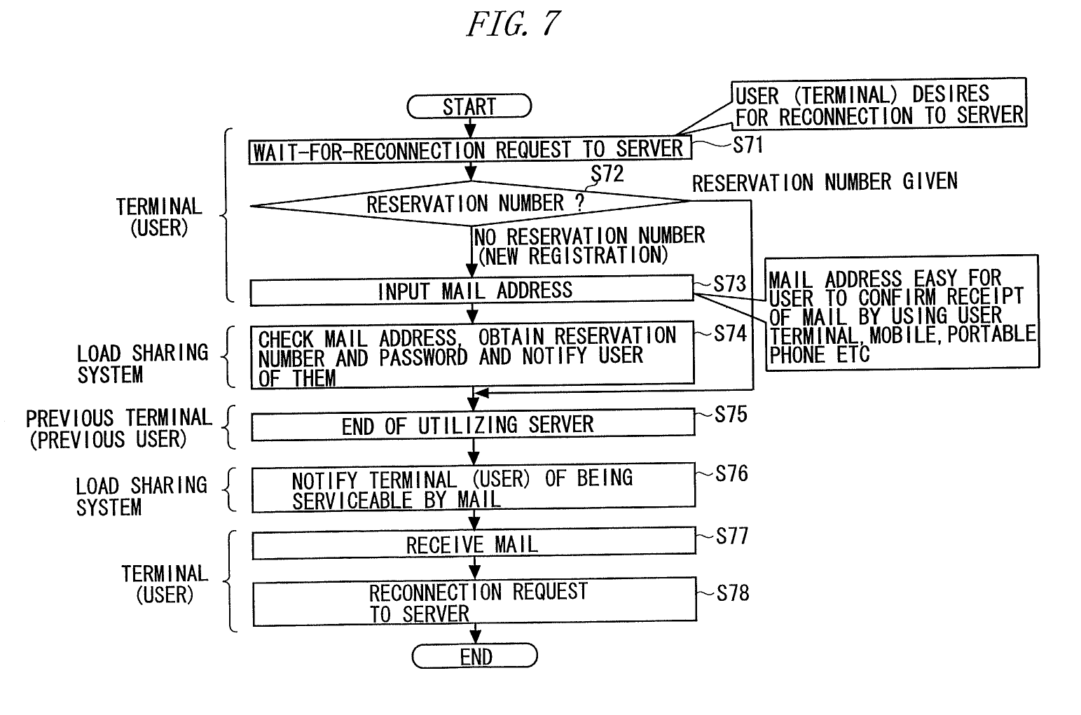

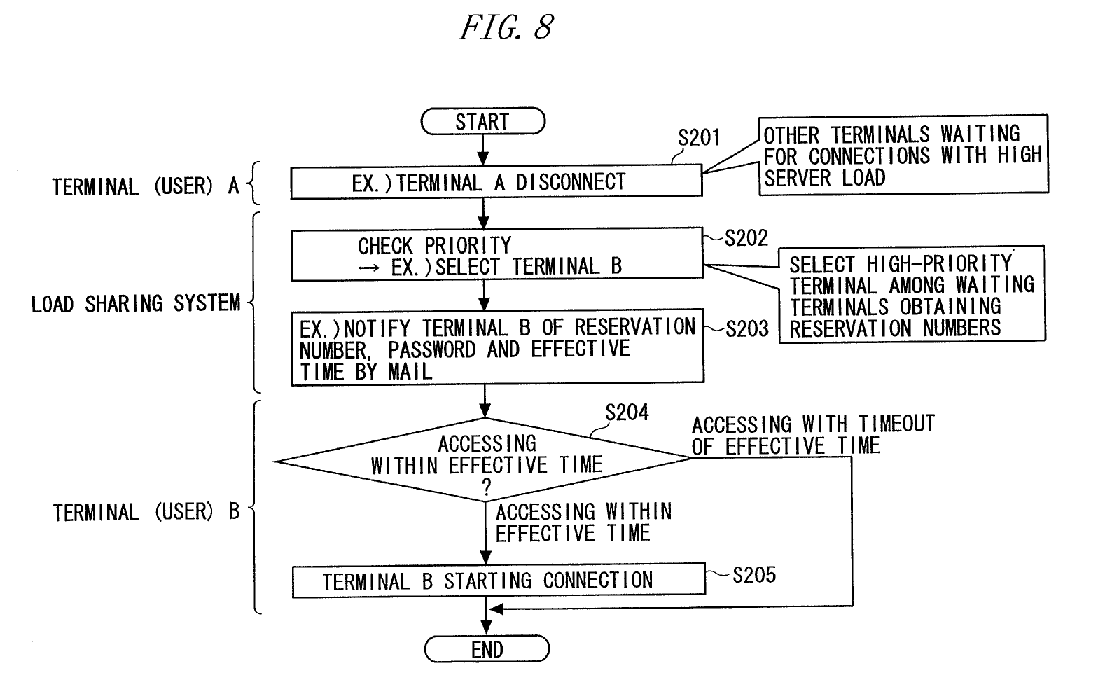

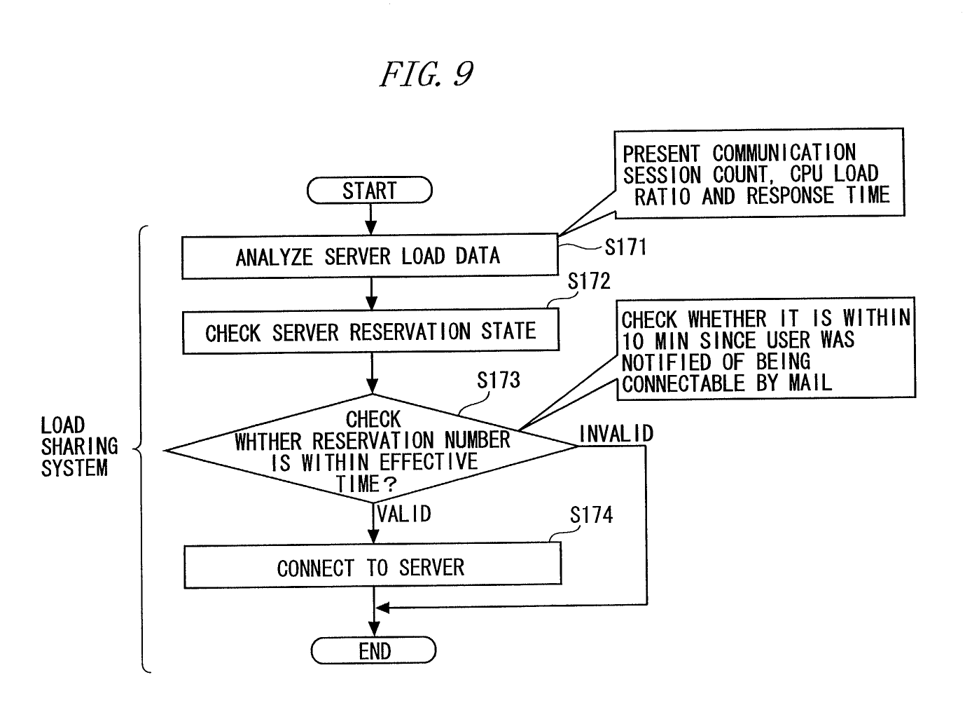

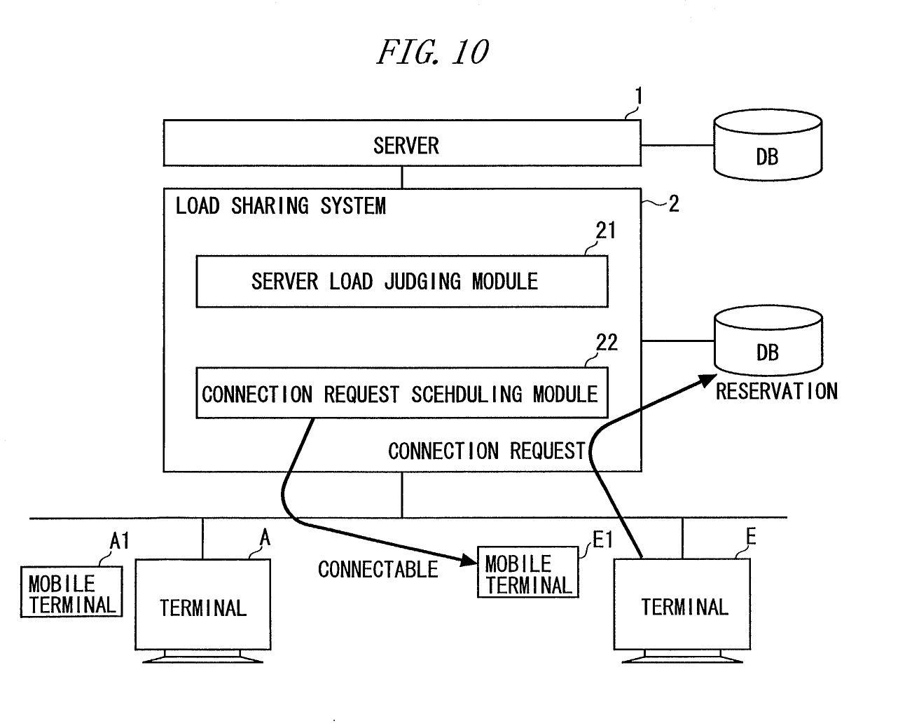

An embodiment of the present invention will hereinafter be described with reference to FIGS. 1 through 10. FIG. 1 is a view showing an architecture as a principle of a load sharing system in this embodiment. FIG. 2 is a diagram showing state transitions of a terminal A and others shown in FIG. 1. FIG. 3 is a diagram showing an example of a screen displayed on the terminal A etc. FIG. 4 shows an example of a terminal table used by the load sharing system 2. FIG. 5 is a flowchart showing processes in the whole system including a server 1, the load sharing system 2, the terminal A and others. FIG. 6 is a flowchart showing details of a server load state check process (S2 in FIG. 5) through a reservation number notifying process (S11 in FIG. 5). FIG. 7 is a flowchart showing details of a wait-for-server selecting process (S7 in FIG. 5) through a re-connection request process (S16 in FIG. 5) in the terminal. FIG. 8 is a flowchart showing a priority transit process in the load sharing system 2. FIG. 9 is a flowchart showing details of the reservation number check process (S17 in FIG. 5) in the load sharing system 2. FIG. 10 is a view showing a modified example of the present invention, which utilizes a mobile terminal.

<System Architecture>

FIG. 1 is the view showing the architecture as the principle of the load sharing system 2 in this embodiment. This load sharing system 2 is connected to the server 1 and the terminals A through E, and provides a function of sharing a load of the server 1. The server 1 provides a database management function, an online processing function, an algorithm calculating function or others.

The load sharing system 2 and the sever 1 described above may be defined as computers each including a CPU, a memory, a hard disk, a telecommunication board etc and accessible to a network. A hardware architecture and operations of this type of computer are broadly known, and therefore their explanations are omitted.

Further, each of the terminals A through E is a personal computer including a CPU, a memory, a hard disk, a telecommunication board, a display device, a pointing device etc, or a computer such as the PDA and so on. A hardware architecture and operations of this type of personal computer etc are broadly known, and therefore their explanations are omitted.

As illustrated in FIG. 1, this load sharing system 2 includes a server load state check module 21 and a connection request scheduling module 22. These modules are defined as a program executed by the unillustrated CPU of the load sharing system 2.

The server load state check module 21 inquires of the server 1 about an operating state and judges a load state. This load state is determined based on a communication session count of sessions (connections) to the server 1, a CPU load ratio of the server 1 and a response time of the server 1.

Herein, the communication session count is the number of connections, i.e., the number of the terminals connected to the server 1 at the present time. Being connected to the server 1 implies that a communication process of the terminal A etc and a communication process of the server 1 establish a communication state based on a predetermined protocol. This state may also be a session established state.

Moreover, the CPU load ratio is defined as a ratio of an occupying time (a ratio with respect to a total value of an occupying time and non-occupying time) for which the CPU executes the program. Further, the response time is defined as a time till, when, for example, the load sharing system 2 sends an inquiry to the server 1, a response to this inquiry is sent back.

The connection request scheduling module 22 accepts a connection request from the terminal A etc, and judges based on the load of the server 1 whether the connection can be established or not. Then, the connection request scheduling module 22, when judging that the connection can not be established, rejects this connection request but reserves this connection. Then, the connection request scheduling module 22, when the load of the server 1 decreases down to a predetermined range, connects the terminal A etc waiting for the connection to the server 1 on the basis of the reservation thereof. The connection state and the reservation state of the terminal A etc are recorded on the database of the load sharing system 2.

<Transition of Terminal State>

FIG. 2 shows the state transitions of the terminals A through E each requesting the load sharing system 2 to establish the connection.

Referring to FIG. 2, in an initial state 101, the respective terminals are in the following states. The terminal A is on the connection, the terminal B waits for the connection (its reservation number is 005), the terminal C is on the connection, the terminal D waits for the connection (its reservation number is 006), and the terminal E waits for the connection (its reservation number is 0007).

Further, as reconnection schedule times, 13:50 is set in the terminal B, 14:00 is set in the terminal D, and 14:10 is set in the terminal E. Herein, the reconnection schedule time is a connection schedule time estimated just when the connection is reserved. The load sharing system 2 in this embodiment, if this reconnection schedule time does not elapse, does not connect the reserved terminal.

In this state 101, it is assumed that the terminal B again makes the connection request at 14:02 (arrow 102). In this case, an overload of the server 1 is not obviated. The terminal B therefore again sets the reconnection schedule time several minutes later, thus becoming a state 103.

Further, it is assumed that the on-connection terminal A is disconnected at 14:05. The terminal B having the lowest reservation number, i.e., the highest priority is notified of a mail that prompts the terminal B to establish the connection. The load sharing system 2 according to this embodiment assures the connection only for a predetermined period from the mail notification. In this embodiment, this period is set to 10 minutes. Accordingly, the terminal B is given an assurance of the connection up to 14:15.

It is herein presumed that, for instance, the terminal E makes the connection request at 14:12 (arrow 104). In this case, with the disconnection of the terminal A, the overload of the server 1 is obviated. The terminal B has already been, however, given the assurance of the connection up to 14:15. Therefore, the terminal E is not permitted to establish the connection (state 105).

Next, it is assumed in the state 101 that the terminal B does not make reconnection request till 14:15, and the terminal D makes the reconnection request at 14:20 (arrow 106). In this case, the terminal B did not make the reconnection request till 14:15, and hence the reservation number, i.e., the priority is lowered down 008 from 005. Further, the overload of the server 1 is obviated at 14:20. Moreover, the present time elapses over the reconnection schedule time, i.e., 14:00, so that the connection request of the terminal D is admitted, thereby transiting to a state 107.

<Screen Layout>

FIG. 3 shows the example of the screen displayed on the terminal A etc. A connection button 30 for requesting the server 1 to establish the connection is displayed on the screen in FIG. 3. When the user presses the connection button 30 with an unillustrated pointing device, a window notifying of [user congestion] is displayed. Displayed on this window is a message saying “User congestion, the workflow service is hard to offer due to user congestion, (100 users connected, 50 users waiting for connections, and the average connection time being 5 min/user). We are giving you inconveniences but would like you to wait in this state. You will be re-connectable 10 min later”.

Further, a “wait-for-reconnection” button 31, a “notified-of-password-by-mail” button 32 and “non-wait (end)” button 33, are displayed on this window.

When the user presses the “wait-for-reconnection” button 31, a mail address input window 34 is displayed. This mail address input window 34 displays a message prompting the user to input a mail address and notifying the user by mail that the service can be received, and also a message giving a caution that the connection be established within 10 min since the mail notification was received.

When the user inputs a message into a mail address input box, a reservation number and a re-connectable time (estimated) are displayed. The user already having obtained the reservation number is, however, prompted to press a “reservation-number-obtained (close)” button. This “reservation-number-obtained (close)” button is the same process (function) as the “non-wait (end)” button 33 to the user already notified of the reservation number, and the mail address input window 34 is closed as it is.

The user already notified of the reservation number and the password presses the “notified-of-password-by-mail” button 32. Then, a reservation number input window 35 is displayed. This reservation number input window 35 contains an reservation number input box and a password input box.

When the user inputs the reservation number and the password into the reservation number input box and the password in put box, the connection request is accepted if the reservation number and the password are valid within an effective connection assurance period, whereby the terminal A etc of the user is connected to the server 1.

Further, when the user presses the “no-wait (end)” button 33, the window notifying of “user congestion” is closed, thus finishing the connection request.

<Data Structure>

FIG. 4 shows the example of the terminal table retained by the load sharing system 2. The terminal table is defined as a table for managing the terminals A through E making the connection requests. Each of lines in this terminal table corresponds to a record of data entered in a “user” field, a “reconnection schedule time” field, a “terminal state” field, a “reservation number” field and a “simple password” field.

The “user” field is recorded with information for identifying the terminal. The “reconnection schedule time” field is recorded with a connectable schedule time after reserving the connection. The “terminal state” field is recorded with a state of the terminal of the connection to the server 1. According to this embodiment, there are prepared three categories of terminal states such as an “on-connection” state, a “wait-for-connection” state and a “new connection request” state.

The “on-connection” state is a state where one of the terminals A through E is connected to the server 1, and the communications are performed. Further, the “wait-for-connection” state is a state where the connection is, though requested, not admitted but reserved. Moreover, the “new connection request” state indicates that the terminal not yet connected is making the connection request.

In the terminal table shown in a left upper portion in FIG. 4, the maximum value of the reservation number (of the terminal D) at the present is “6”. In this state, when the terminal E not yet connected makes the connection request, the load sharing system 2 calculates and sets a reconnection schedule time on the basis of the present connection state and waiting state. In this case, an estimation standard may be set by an administrator of the load sharing system 2.

According to this embodiment, for instance, an average waiting time of one single terminal, an average connection time of one single terminal and others may be selected as elements of this estimation standard. These average values are calculated for one day, one week, one month etc in the past.

In the case of the “new connection request” of the terminal, a reservation number is further set. The reservation number for the new connection request is set to a value into which the present maximum value is incremented by “1”. Thus, as seen in the lower table in FIG. 4, the reconnection schedule time (14:10) and the reservation number (7) are set for the terminal E having made the new connection request.

<Operation>

FIG. 5 shows the processing flow of the whole system in the load sharing system 2. In this process, at first, the terminal requests the load sharing system 2 to establish the connection (S1). Then, the load sharing system 2 requests the server 1 to check a load state (S2).

Responding to this, the server 1 informs the load sharing system 2 of various items of data indicating the load state (S3). These items of data are, for example, a communication session count, a CPU load ratio, a response time etc. The load sharing system 2 judges based on these items of data whether the load is a light load or an overload (S4). Then, in the case of the light load, the load sharing system 2 directly connects the terminal to the server 1 (S5).

While on the other hand, in the case of the overload, the load sharing system 2 notifies the terminal that the server 1 can not be utilized (S6). Then, the terminal prompts the user to select whether to wait for the server 1 to become free. If the user selects not to wait for the server 1 to become free, the terminal finishes the process (S8).

If the user selects to wait for the server 1 to become free, the terminal notifies the load sharing system 2 of this selection. Then, the load sharing system 2 executes a wait-for-connection setting process with respect to the server 1 (S9).

In this case, the load sharing system 2 displays the mail address input box 34 on the terminal and prompts the user to input a mail address (S10). When the user inputs the mail address, this piece of information is transferred to the load sharing system 2 from the terminal. Then, the load sharing system 2 transmits a wait-for-connection setting notification containing the reservation number etc to the terminal (S11) The terminal receives the wait-for-connection setting notification containing the reservation number etc transmitted (S12).

In this state, when the on-connection user finishes utilizing the server 1, any one of the on-connection terminals is disconnected (S13), and the load sharing system 2 is notified of this disconnection. Then, the load sharing system 2 notifies the terminal having a reservation number indicating a high priority, of a mail showing a permission of the connection (S14) The terminal, when receiving this mail (S5), again prompts the user to make the reconnection to the server 1. In this case, the user input the reservation number etc. The terminal, based on the reservation number etc inputted, executes the reconnection request to the server 1 (S16).

Then, the load sharing system 2 checks a validity of the reservation number etc, for instance, whether or not this reservation number is an effective reservation number reaching the connection schedule time (S17). Then, when the valid reservation number etc is inputted, the load sharing system 2 connects the terminal to the server 1.

FIG. 6 shows the details of the server load state check process (S2 in FIG. 5) through the reservation number notifying process (S11 in FIG. 5). In this process, the load sharing system 2, to begin with, checks the communication session count, the CPU load ratio, the response time etc of the server 1 (S21). The data items checked herein are set beforehand by the system administrator.

Next, the load sharing system 2 checks a load state of the server 1 on the basis of the communication session count, the CPU load ratio, the response time etc (S22). Then, the load sharing system 2 judges the load state of the server 1 (S23) When judging in S23 that the load is light, the load sharing system 2 finishes the process. While on the other hand, when judging in S23 that it is the overload, the load sharing system 2 notifies the terminal of a message showing the overload (S24).

Then, the load sharing system 2 prompts the user to select whether the reconnection is made or not through the terminal (S25). If the user selects not to make the reconnection, the terminal directly finishes the process. Whereas if the user selects the reconnection, the terminal prompts the user to input the mail address (S26). When the mail address is inputted, the terminal transmits this piece of information to the load sharing system 2.

The load sharing system 2 sets the reservation number and the password and notifies the terminal of them (S27). Thereafter, the load sharing system 2 finishes the process.

FIG. 7 shows the details of the wait-for-server selection process (S7 in FIG. 5) through the reconnection-request-to-the-server 1 process (S16 in FIG. 5) in the terminal.

An execution of this process is triggered when the user desires the reconnection to the server 1. In this case, the terminal transmits to the load sharing system 2 a wait-for-reconnection request to the server 1 (S71).

Then, the load sharing system 2 inquires of the terminal whether the user has the reservation number. If the user has the reservation number, the terminal advances the control to S75 and waits for the on-connection user to finish.

Whereas if the user does not have the reservation number, the terminal prompts the user to input the mail address (S73) This mail address is delivered to the load sharing system 2 from the terminal.

The load sharing system 2 receives the mail address. Then, the load sharing system 2, after confirming a validity of the mail address, obtains a reservation number and a password and notifies the user terminal of the same reservation number and password (S74).

When the user who is in the process of utilizing the server 1 finishes the process (S75), a connectable notification is transmitted by mail to the high-priority terminal (S76). Then, this terminal receives the mail (S74) and displays it. The terminal transmits the connection request to the server 1 in accordance with an indication of the user (S78). Thereafter, the terminal finishes the process.

FIG. 8 shows a priority transition process in the load sharing system 2 after the on-connection terminal has finished the connection to the server 1. It is now assumed that the load on the server 1 be high and there be the terminals waiting for the connections with reservation. This process starts in such a state just when the terminal remaining connected to the server 1 disconnects therefrom (S201).

Then, the load sharing system 2 checks the priority (S202). Subsequently, the load sharing system 2 selects a higher-priority terminal, e.g., the terminal B as the terminal that should be connected next. Then, the load sharing system 2 notifies the terminal B of a reservation number, a password and an effective time by mail (S203).

Thereupon, the terminal B displays the reservation number and others to the user. Next, the terminal B makes the connection request to the server 1 in accordance with the indication of the user. In this case, the load sharing system 2 judges whether it is an access within the effective time (S204). In the case of the access within the effective time, the terminal B is connected to the server 1 (S205). While on the other hand, in the case of the access out of the effective time, the connection request is rejected, and the terminal finishes the process.

FIG. 9 shoes the details of the reservation number check process (S17 in FIG. 5) in the load sharing system 2. In this process, the load sharing system 2 analyzes the load data of the server 1 (S171). The load data are, e.g., the present communication session count, CPU load ratio, response time and so on.

Next, the load sharing system 2 checks a reservation state of the server 1 (S172). Next, the load sharing system 2 judges whether the reservation number keeps its validity within the effective time (S173). If the reservation number is within the effective time, the load sharing system 2 connects the terminal to the server 1 (S174). Thereafter, the load sharing system 2 finishes the process.

Whereas if the reservation number is not within the effective time, the load sharing system 2 directly finishes the process.

<Effects of Embodiment>

As discussed above, according to the load sharing system 2 in this embodiment, if the load on the server 1 increases, the reservation numbers are given to the terminals A through E making the connection requests to the server 1. Then, when the load on the server 1 is lessened (free of job), the terminals waiting for their connections are connected to the server 1 in the sequence of the reservation numbers.

It is therefore possible to relieve the load caused by limitless accessing of the terminals A through E to the server 1. Further, the terminals A through E wait for a considerable wait time and thereby surely given the assurances for the connections to the server 1.

Further, the load sharing system 2 gives the password to the user and, when the server 1 comes to the connectable state, sends the connectable notification by mail, thereby improving the serviceability to the user.

Moreover, the load sharing system 2, if the load on the server exceeds the predetermined range, notifies the user of the re-accessible time on the basis of the reservation identifying information. The server load caused by the repetitive accesses of the users is relieved, and a user's stress caused by the unaccessible state is obviated.

<Modified Example>

In the embodiment discussed above, the load sharing system 2 is constructed of the computer separate from the server 1 (see FIG. 1). The embodiment of the present invention is not, however, limited to this architecture. For instance, the load sharing system 2 maybe constructed integrally with the server 1. Further, the load sharing system 2 may be made to function as a system 2 that operates a specified server 1 to share the loads on a plurality of other servers 1.

In the embodiment discussed above, the terminal prompts the user to input the reservation number and the password of which the server 1 notified, and transmits the inputted reservation number and password to the load sharing system 2. The embodiment of the present invention is not, however, confined to the architecture and the procedures described above.

For example, the reservation number may be transferred and received by use of Cookie (a user identifying mechanism) utilized between a Web server and Browser. To be specific, the reservation number for the connection may be transferred as a Cookie to the Browser on the terminal, wherein the load sharing system 2 and the server 1 may be defined as Web servers, and the Browser runs on the terminal. Then, the load sharing system 2 may, when connectable, transmit a message simply showing a connectable state to the terminal.

The user may make the connection request to the server 1 without being aware of the reservation number and the password. In this case, when the Browser on the terminal accesses the server 1, the Cookie is transferred to the load sharing system 2, and the reservation number may be thus shown. With this scheme, the user has no necessity of being aware of the reservation number and the password.

As described above, according to the present invention, with the password, the connection request can be sent from and the mail notification can be received by whichever terminal, and the connection to the server 1 can be assured if within the fixed period of time since the receipt thereof. Accordingly, the user may exist anywhere if in an easy access to the connectable terminal. Further, the mail may be received by a palm-size mobile terminal different from the connection terminal.

FIG. 10 shows such a system architecture. Referring to FIG. 10, the architecture other than mobile terminals A1 through E1 is the same as in FIG. 1. Referring again to FIG. 10, the mobile terminals A1 through E1 are PDAs (Personal Digital Assistants), mobile phones and PHSs (Personal Handyphone Systems) and so on.

FIG. 10 shows a case where the connection request of the user of, e.g., the terminal E is rejected, and this connection is reserved. In this case, according to the present system, the mobile terminal E1 of the user of the terminal E is set as a destination to which the mail notification showing the permission of the connection is transmitted. Those terminal and mobile terminals are linked to each other, thereby improving the serviceability to the users.

<<Readable-by-Computer Recording Medium>>

The program read by the computer to execute any one of the processes in the embodiment discussed above may be recorded on a readable-by-computer recording medium. Then, the computer reads and executes the program on this recording medium, thereby providing a function as the load sharing system 2 or the terminal exemplified in the embodiment discussed above.

Herein, the readable-by-computer recording medium embraces recording mediums capable of storing information such as data, programs, etc. electrically, magnetically, optically and mechanically or by chemical action, which can be all read by the computer. What is demountable out of the computer among those recording mediums may be, e.g., a floppy disk, a magneto-optic disk, a CD-ROM, a CD-R/W, a DVD, a DAT, an 8 mm tape, a memory card, etc.

Further, a hard disk, a ROM (Read Only Memory) and so on are classified as fixed type recording mediums within the computer.

<<Data Communication Signal Embodied in Carrier Wave>>

Furthermore, the above program may be stored in the hard disk and the memory of the computer, and downloaded to other computers via communication media. In this case, the program is transmitted as data communication signals embodied in carrier waves via the communication media. Then, the computer downloaded with this program can be made to function as the load sharing system 2 or the terminal.

Herein, the communication media may be any one of cable communication mediums such as metallic cables including a coaxial cable and a twisted pair cable, optical communication cables, or wireless communication media such as satellite communications, ground wave wireless communications, etc.

Further, the carrier waves are electromagnetic waves for modulating the data communication signals, or the light. The carrier waves may, however, be DC signals. In this case, the data communication signal takes a base band waveform with no carrier wave. Accordingly, the data communication signal embodied in the carrier wave maybe any one of a modulated broad band signal and an unmodulated base band signal (corresponding to a case of setting a DC signal having a voltage of 0 as a carrier wave).

What is claimed is:

1. A server comprising:
a communication module receiving a connection request from a terminal on a network;
a processing unit providing a function to said terminal connected;
a load judging module judging a load of said processing unit;
a reservation module reserving a connection of a terminal of which a connection is rejected; and
a control module controlling the connection of said terminal,
wherein said control module, when the load of said processing unit exceeds a predetermined range, rejects the connection request but reserves the connection of said terminal in said reservation module, and, when the load of said processing unit falls within the predetermined range, connects said terminal with reservation already made.

2. A server according to claim 1, wherein said control module gives, in the reservation, a piece of reservation identifying information to said terminal of which the connection has been reserved, gives a piece of permission information to said terminal with the reservation already made in sequence of reservation priorities when the load of said processing unit falls within the predetermined range, and connects said terminal when said terminal given the permission information makes a connection request with the reservation identifying information shown.

3. A server according to claim 2, wherein the permission information contains a piece of authenticating information mapped to the reservation identifying information, and
said control module, when said terminal shows the reservation identifying information and the authenticating information, connects said terminal.

4. A server according to claim 2, further comprising a setting module setting information for specifying a destination to which the permission information is transmitted.

5. A server providing a function to a terminal on a network and communicating a notification related to said terminal to a predetermined communication terminal, comprising:
a communication module receiving a connection request from a terminal on a network;
a processing unit providing a function to said terminal connected;
a load judging module judging a load of said processing unit;
a reservation module reserving a connection of a terminal of which a connection is rejected; and
a control module controlling the connection of said terminal,
wherein said control module, when the load of said processing unit exceeds a predetermined range, rejects the connection request but reserves the connection of said terminal in said reservation module, and, when the load of said processing unit falls within the predetermined range if the connection of said terminal is reserved in said reservation module, gives the permission information indicating a permission of the connection to said communication terminal.

6. A terminal connected to a server on a network and provided with a function from said server, comprising:
a communication module making a connection request to said server;
a recording module recording information; and
a control module controlling the connection to said server,
wherein said control module, when the connection is rejected, receives and records said recording module with a piece of reservation identifying information indicating a reservation of connection, and when making the connection request to said server next time, shows the reservation identifying information.

7. A load management method, executed by a computer, comprising:
receiving a connection request from a terminal on a network;
controlling a processing unit actualizing a predetermined function to provide this function to said terminal connected;
judging a load of said processing unit;
connecting said terminal making the connection request when the load of said processing unit does not exceed a predetermined range;
rejecting, when the load of said processing unit exceeds the predetermined range, the connection request but reserving the connection of said terminal; and
connecting, when the load of said processing unit falls within the predetermined range, said terminal with the reservation already made.

8. A load management method according to claim 7, wherein said reserving the connection involves giving a piece of reservation identifying information to said terminal making the connection request, and
said connecting said terminal includes, when the load of said processing unit falls within the predetermined range, giving a piece of permission information to said terminal with the reservation already made in sequence of reservation priorities, and, when said terminal given the permission information makes a connection request with the reservation identifying information shown, permitting said terminal to be connected.

9. A load management method according to claim 8, wherein the permission information contains a piece of authenticating information mapped to the reservation identifying information, and
said connecting said terminal involves, when said terminal shows the reservation identifying information and the authenticating information, permitting said terminal to be connected.

10. A load management method according to claim 8, further comprising prompting to set information for specifying a destination to which the permission information is transmitted.

11. A load management method of transmitting a notification related to a terminal on a network to a predetermined communication terminal and managing a load on a computer to which said terminal is connected, said method comprising:
receiving a connection request from a terminal on a network;
controlling a processing unit actualizing a predetermined function to provide this function to said terminal connected;
judging a load of said processing unit;
connecting said terminal making the connection request when the load of said processing unit does not exceed a predetermined range;
rejecting, when the load of said processing unit exceeds the predetermined range, the connection request but reserving the connection of said terminal; and
giving, when the load of said processing unit falls within the predetermined range, a piece of permission information indicating a connection permission to said communication terminal.

12. A method of making a terminal on a network connect to a server and making said terminal receive a function provided from said server, said method comprising:
making said server on the network to establish a connection;
receiving a piece of reservation identifying information indicating a reservation of the connection when the connection is rejected; and
making said terminal show the reservation identifying information when making the connection request to said server next time.

13. A readable-by-computer recording medium recorded with a program, executed by a computer, comprising:
receiving a connection request from a terminal on a network;
controlling a processing unit actualizing a predetermined function to provide this function to said terminal connected;
judging a load of said processing unit;
connecting said terminal making the connection request when the load of said processing unit does not exceed a predetermined range;
rejecting, when the load of said processing unit exceeds the predetermined range, the connection request but reserving the connection of said terminal; and
connecting, when the load of said processing unit falls within the predetermined range, said terminal with the reservation already made.

14. A readable-by-computer recording medium recorded with a program according to claim 13, wherein said reserving the connection involves giving a piece of reservation identifying information to said terminal making the connection request, and
said connecting said terminal includes, when the load of said processing unit falls within the predetermined range, giving a piece of permission information to said terminal with the reservation already made in sequence of reservation priorities, and, when said terminal given the permission information makes a connection request with the reservation identifying information shown, permitting said terminal to be connected.

15. A readable-by-computer recording medium recorded with a program according to claim 14, wherein the permission information contains a piece of authenticating information mapped to the reservation identifying information, and
said connecting said terminal involves, when said terminal shows the reservation identifying information and the authenticating information, permitting said terminal to be connected.

16. A readable-by-computer recording medium recorded with a program according to claim 14, further comprising prompting to set information for specifying a destination to which the permission information is transmitted.

17. A readable-by-computer recording medium recorded with a program executed by a computer to transmit a notification related to a terminal on a network to a predetermined communication terminal and to manage a load on a computer to which said terminal is connected or a load on other computer, said program comprising:
receiving a connection request from a terminal on a network;
controlling a processing unit actualizing a predetermined function to provide this function to said terminal connected;
judging a load of said processing unit;
connecting said terminal making the connection request when the load of said processing unit does not exceed a predetermined range;
rejecting, when the load of said processing unit exceeds the predetermined range, the connection request but reserving the connection of said terminal; and
giving, when the load of said processing unit falls within the predetermined range, a piece of permission information indicating a connection permission to said communication terminal.

18. A readable-by-computer recording medium recorded with a program for making a terminal on a network connect to a server and making said terminal receive a function provided from said server, said program comprising:
requesting said server on the network to establish a connection;
receiving apiece of reservation identifying information indicating a reservation of the connection when the connection is rejected; and
showing the reservation identifying information when making the connection request to said server next time.
